(19) United States
(12) Patent Application Publication
(10) Pub. No.: US 2023/0259590 A1
(43) Pub. Date: Aug. 17, 2023

(54) AUTOMATING DISCOVERY OF PATENTABLE SUBJECT MATTER

(71) Applicant: UAB 360 IT, Vilnius (LT)

(72) Inventors: Ramunas Markauskas, Vilnius (LT); Povilas Poderskis, Vilnius (LT)

(73) Assignee: UAB 360 IT, Vilnius (LT)

(21) Appl. No.: 17/670,457

(22) Filed: Feb. 13, 2022

(51) Int. Cl. G06F 21/10; G06Q 50/18; G06F 16/25

(52) U.S. Cl. CPC G06F 21/10; G06Q 50/184; G06F 16/25

(57) ABSTRACT

A method including receiving, at an infrastructure device, a merge request to request a change to at least a portion of software; determining, by the infrastructure device based at least in part on receiving the merge request, a likelihood that the change includes potentially patentable subject matter; and selectively triggering, by the infrastructure device, a discovery process to evaluate the likelihood that the change includes potentially patentable subject matter. Various other aspects are contemplated.

### FIELD OF DISCLOSURE

Aspects of the present disclosure generally relate to discovering patentable subject matter, and more particularly to automating discovery of patentable subject matter.

### BACKGROUND

Ability of a business entity to increase its market share, generate profits, and improve productivity is increasingly linked to its intellectual property. Such intellectual property may include, for example, patents, copyrights, trademarks, trade secrets, licenses, or the like. Patents, in particular, may be valuable and beneficial to the business entity because patents afford various advantages. In an example, patents may facilitate investment by others in the business entity. In another example, patents may allow the business entity to protect products, machines, compositions, and processes owned by the business entity by preventing competitors from, among other things, making, using, and/or selling infringing products, machines, compositions, and processes. In yet another example, patents may allow the business entity to deter a potential accuser of infringement from suing the business entity because the potential accuser may want to avoid the business entity from asserting patents owned by the business entity against the potential accuser. Further, patents may allow the business entity to offer licenses to its patents as a way to monetize the intellectual property and increase revenue. Additionally, industry-leading patents may allow the business entity to establish and advance its reputation in the industry.

### SUMMARY

In one aspect, the present disclosure contemplates a method including receiving, at an infrastructure device, a merge request to request a change to at least a portion of software; determining, by the infrastructure device based at least in part on receiving the merge request, a likelihood that the change includes potentially patentable subject matter; and selectively triggering, by the infrastructure device, a discovery process to evaluate the likelihood that the change includes potentially patentable subject matter.

In another aspect, the present disclosure contemplates an infrastructure device including a memory and a processor configured to: receive a merge request to request a change to at least a portion of software; determine, based at least in part on receiving the merge request, a likelihood that the change includes potentially patentable subject matter; and selectively trigger a discovery process to evaluate the likelihood that the change includes potentially patentable subject matter.

In another aspect, the present disclosure contemplates a non-transitory computer readable medium storing instructions, which when executed by a processor associated with a device, cause the processor to: receive a merge request to request a change to at least a portion of software; determine, based at least in part on receiving the merge request, a likelihood that the change includes potentially patentable subject matter; and selectively trigger a discovery process to evaluate the likelihood that the change includes potentially patentable subject matter.

Aspects generally include a method, an apparatus, a system, a device, a computer program product, a non-transitory computer-readable medium, a control infrastructure, a wireless communication device, and/or processing system as substantially described herein with reference to and as illustrated by the drawings and specification.

It is to be understood that both the foregoing general description and the following detailed description are exemplary and explanatory in nature and are intended to provide an understanding of the present disclosure without limiting the scope thereof. In that regard, additional aspects, features, and advantages of the present disclosure will be apparent to one skilled in the art from the following detailed description.

### BRIEF DESCRIPTION OF THE DRAWINGS

The accompanying drawings illustrate aspects of systems, devices, methods, and/or mediums disclosed herein and together with the description, serve to explain the principles of the present disclosure. Throughout this description, like elements, in whatever aspect described, refer to common elements wherever referred to and referenced by the same reference number. The characteristics, attributes, functions, interrelations ascribed to a particular element in one location apply to those elements when referred to by the same reference number in another location unless specifically stated otherwise.

The figures referenced below are drawn for ease of explanation of the basic teachings of the present disclosure; the extensions of the figures with respect to number, position, relationship, and dimensions of the parts to form the following aspects may be explained or may be within the skill of the art after the following description has been read and understood. Further, exact dimensions and dimensional proportions to conform to specific force, weight, strength, and similar requirements will likewise be within the skill of the art after the following description has been read and understood.

The following is a brief description of each figure used to describe the present disclosure, and thus, is being presented for illustrative purposes only and should not be limitative of the scope of the present disclosure.

FIG. 1 is an illustration of an example system associated with automating discovery of patentable subject matter, according to various aspects of the present disclosure.

FIG. 2 is an illustration of an example flow associated with automating discovery of patentable subject matter, according to various aspects of the present disclosure.

FIG. 3 is an illustration of an example associated with automating discovery of patentable subject matter, according to various aspects of the present disclosure.

FIG. 4 is an illustration of an example process associated with automating discovery of patentable subject matter, according to various aspects of the present disclosure.

FIG. 5 is an illustration of example devices associated with automating discovery of patentable subject matter, according to various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

For the purposes of promoting an understanding of the principles of the present disclosure, reference will now be made to the aspects illustrated in the drawings, and specific language may be used to describe the same. It will nevertheless be understood that no limitation of the scope of the disclosure is intended. Any alterations and further modifications to the described devices, instruments, methods, and any further application of the principles of the present disclosure are fully contemplated as would normally occur to one skilled in the art to which the disclosure relates. In particular, it is fully contemplated that the features, components, and/or steps described with respect to one aspect may be combined with the features, components, and/or steps described with respect to other aspects of the present disclosure. For the sake of brevity, however, the numerous iterations of these combinations may not be described separately. For simplicity, in some instances the same reference numbers are used throughout the drawings to refer to the same or like parts.

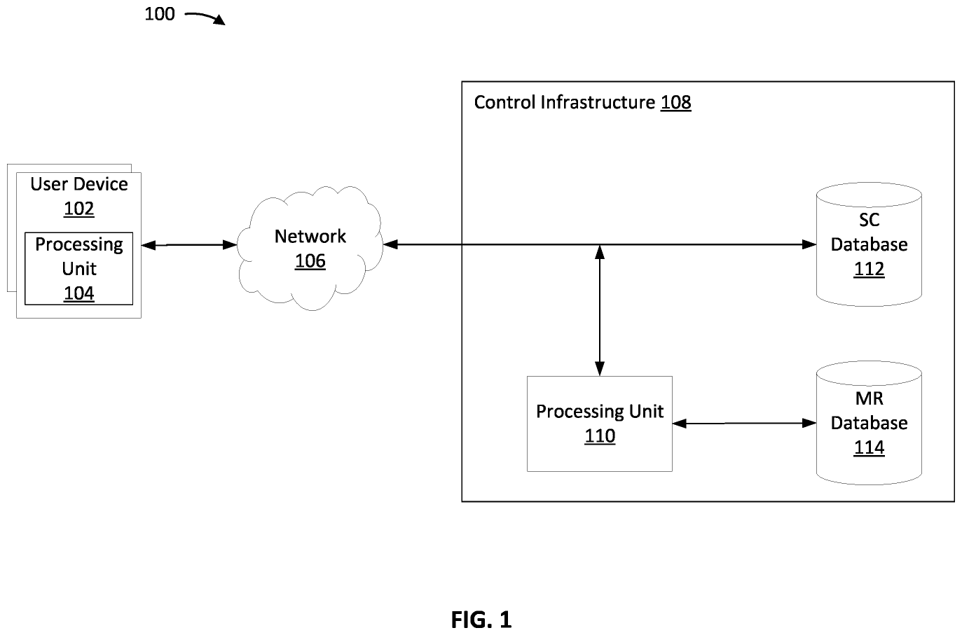

FIG. 1 is an illustration of an example 100 associated with automating discovery of patentable subject matter, according to various aspects of the present disclosure. Example 100 shows an architectural depiction of included components. In some aspects, the components may include one or more user devices 102 capable of communicating with a control infrastructure 108. In some aspects, the one or more user devices 102 may communicate with the control infrastructure 108 over a network 106. In some aspects, a user device 102 may include a processing unit 104. The control infrastructure 108 may be controlled by a business entity and may include a processing unit 110, a source code database (SC database) 112, and a merge request database (MR database) 114. The SC database 112 may be configured to store, among other things, a source code that enables operations of the business entity including, for example, providing products and services. The MR database 114 may be configured to store merge request information. The processing unit 110 may be configured to control operation of the SC database 112 and the MR database 114. Further, processing unit 110 may be configured to communicate with the SC database 112 and the MR database 114 to retrieve and/or store and/or update data. Further, the processing unit 110 may be configured to receive requests associated with the SC database 112, including, for example, retrieve or store or update or change data in the SC database 112. Additionally, the processing unit 110 may be configured to retrieve or store or update or change merge request information (MR information) in the MR database 114.

A user device 102 may be a physical computing device capable of hosting client applications and of connecting to the network 106. The user device 102 may include any wired and/or wireless communication device such as, for example, a laptop, a mobile phone, a tablet computer, a desktop computer, a smart device, or the like. In some aspects, the business entity may provide the user device 102 to a user (e.g., an employee, an agent, etc.). In this way, the control infrastructure 108 may be associated with the user device 102. The network 106 may be any digital telecommunication network that permits several nodes to share and access resources via a wired and/or wireless medium. In some aspects, the network 106 may include one or more of, for example, a local-area network (LAN), a wide-area network (WAN), a campus-area network (CAN), a metropolitan-area network (MAN), a home-area network (HAN), Internet, Intranet, Extranet, and/or Internetwork.

The control infrastructure 108 may include a combination of hardware and software components that enable provision of products and services. The control infrastructure 108 may enable the user device 102 to access and/or communicate with the control infrastructure 108 via a connection. In some aspects, the control infrastructure 108 may receive, via the network 106, a connection request from the user device 102 to establish the connection with the control infrastructure 108. The connection request may include an authentication request to authenticate the user device 102.

The control infrastructure 108 may further be configured to handle the connection request by mediating the authentication request. For instance, the control infrastructure 108 may receive from the user device 102 credentials including, for example, a unique combination of a user ID and password for purposes of authenticating the user device 102. In another example, the credentials may include a unique validation code known to an authentic user (e.g., an employee, an agent, etc.). The control infrastructure 108 may utilize a user database (not shown) for verification of the credentials.

The user database may include a structured repository of valid credentials belonging to authentic users. In one example, the structured repository may include one or more tables containing valid unique combinations of user IDs and passwords belonging to authentic users. In another example, the structured repository may include one or more tables containing valid unique validation codes associated with authentic users. The business entity may add or delete such valid unique combinations of user IDs and passwords from the structured repository at any time. Based at least in part on receiving the credentials, the control infrastructure 108 may utilize the user database and a processor (e.g., the processing unit 110 or another local or remote processor) to verify the received credentials by matching the received credentials with the valid credentials stored in the structured repository. In some aspects, the control infrastructure 108 may authenticate the user device 102 when the received credentials match at least one of the valid credentials. In this case, the business entity may accept the connection request and enable the user device 102 to establish the connection with the control infrastructure 108. When the received credentials fail to match at least one of the valid credentials, the control infrastructure 108 may fail to authenticate the user device 102. In this case, the control infrastructure 108 may decline the connection request received from the user device 102. When the user device 102 is authenticated, the user device 102 may establish the connection to access and/or communicate with the control infrastructure.

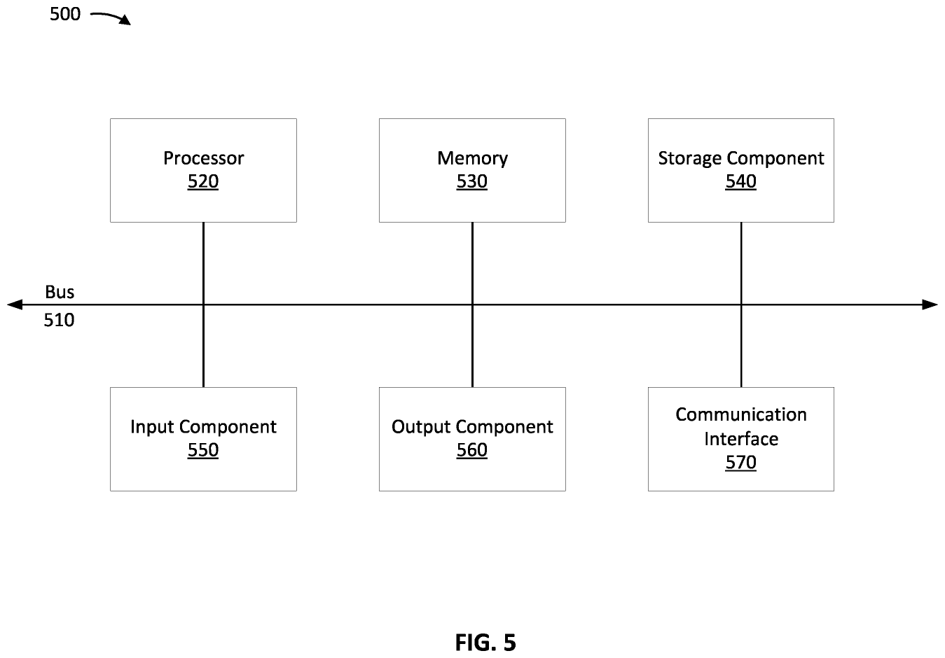

One or more components (e.g., processing unit 104, processing unit 110, SC database 112, and/or MR database 114) associated with the control infrastructure 108 and/or associated with the user device 102 may further be associated with a controller/processor, a memory, a communication interface, or a combination thereof (e.g., FIG. 5). For instance, the one or more components of the set of components may include or may be included in a controller/processor, a memory, or a combination thereof. In some aspects, the one or more of the components included in the control infrastructure 108 may be separate and distinct from each other. Alternatively, in some aspects, the one or more of the components included in the control infrastructure 108 may be combined with one or more of other components included in the control infrastructure 108. In some aspects, the one or more of the components included in the control infrastructure 108 and/or the user device 102 may be local with respect to each other. Alternatively, in some aspects, the one or more of the components included in the control infrastructure 108 and/or the user device 102 may be located remotely with respect to one or more of other components included in the control infrastructure 108 and/or the user device 102. Additionally, or alternatively, the one or more components of the components included in the control infrastructure 108 and/or the user device 102 may be implemented at least in part as software stored in a memory. For example, a component (or a portion of a component) may be implemented as instructions or code stored in a non-transitory computer-readable medium and executable by a controller or a processor to perform the functions or operations of the component. Additionally, or alternatively, a set of (one or more) components shown in FIG. 1 may be configured to perform one or more functions described as being performed by another set of components shown in FIG. 1.

As indicated above, FIG. 1 is provided as an example. Other examples may differ from what is described with regard to FIG. 1.

A business entity may rely on its agents (e.g., employees, officers, scientists, engineers, contractors, etc.) to discover, pursue, and protect its intellectual property. With respect to patents, the business entity may rely on, for example, scientists (e.g., developers, engineers, etc.) to discover and pursue subject matter that may be novel and nonobvious. In an example, the scientists may conduct research and development activities to enable the business entity to provide new products and services and/or to improve provision of existing products and services. Conducting such research and development activities may lead the scientists to, for example, create new solutions and/or improve existing solutions. Such new solutions and/or improvements to existing solutions may involve utilization of novel and nonobvious processes, products, machines, and/or compositions, and may include potentially patentable subject matter.

Relying on agents to discover and pursue the potentially patentable subject matter may not be feasible for several reasons. In an example, an agent may fail to understand what constitutes patentable subject matter, and may fail to appreciate that a new solution and/or an improvement to an existing solution includes patentable subject matter. In another example, creating new solutions and/or improving existing solutions, and not discovering and pursuing patentable subject matter, may be a primary function associated with employment of the agent by the business entity. As a result, the agent may focus on creating new solutions and/or improving existing solutions, thereby inadvertently giving short shrift to discovering and pursuing patentable subject matter. In yet another example, the agent may be less than motivated to discover and pursue patentable subject matter because discovering and pursuing patentable subject matter may involve tedious activities including, for example, detailed documentation and/or recordation of research and development activities, collaborating with patent attorneys to prepare and prosecute patent applications, or the like. For one or more of the above reasons, the agent may fail to identify patentable subject matter. Consequently, the business entity may fail to pursue the patentable subject matter and, therefore, miss out on an opportunity to increase its intellectual property.

Additionally, the business entity may inefficiently expend a threshold amount of business resources (e.g., management resources, computing resources, employee resources, etc.) to discover and pursue patentable subject matter, which business resources may otherwise be utilized more efficiently to provide the products and services.

Various aspects of systems and techniques discussed in the present disclosure enable automating discovery of patentable subject matter. In some aspects, a business entity may utilize a infrastructure device (e.g., processing unit 110), associated with control infrastructure owned and operated by the business entity, to discover and identify potential patentable subject matter. In an example where the business entity may provide products and services based at least in part on execution of software (e.g., a source code) that is stored in an SC database (e.g., SC database 112), the infrastructure device may be configured to accept and process requests associated with the source code. Such requests may include requests to retrieve at least a portion of the source code, requests to change the source code (e.g., merge request), etc. A request to change may include, for example, a request to add to the source code, a request to update the source code, a request to revise the source code, a request to delete a portion of the source code, or the like. In some aspects, the requested change may be directed to creating a new solution and/or improving an existing solution. In some aspects, the merge request may be communicated by one or more user devices associated with the business entity and/or the control infrastructure 108. In some aspects, the infrastructure device may determine that a received request is a merge request. Based at least in part on determining that the received request is the merge request, the infrastructure device may be configured to automatically analyze metadata associated with the merge request and/or to automatically conduct a preliminary determination as to whether the change includes patentable subject matter. Based at least in part on a result of the preliminary determination, the infrastructure device may be configured to selectively trigger a discovery process to discover patentable subject matter. Selectively triggering the discovery process may include, for example, communicating discovery information associated with the merge request and/or the metadata associated with the merge request and/or the result of the preliminary determination to appropriate personnel. The appropriate personnel may analyze/evaluate the discovery information to determine whether the new solution and/or improvement to an existing solution associated with the change includes patentable subject matter.

In this way, by relying on the control infrastructure to automatically discover and identify potentially patentable subject matter, the business entity may be enabled to avoid failure to identify patentable subject matter. As a result, the business entity may enhance a likelihood of increasing its intellectual property. Additionally, the business entity may avoid inefficiently expending a threshold amount of business resources (e.g., management resources, computing resources, employee resources, etc.) to discover and pursue patentable subject matter, and utilize the business resources more efficiently to provide products and services.

In some aspects, a processor (e.g., processing unit 110, processor 520) associated with an control infrastructure may receive a merge request to request a change to at least a portion of software; determine, based at least in part on receiving the merge request, a likelihood that the change includes potentially patentable subject matter; and selectively trigger a discovery process to evaluate the likelihood that the change includes potentially patentable subject matter.

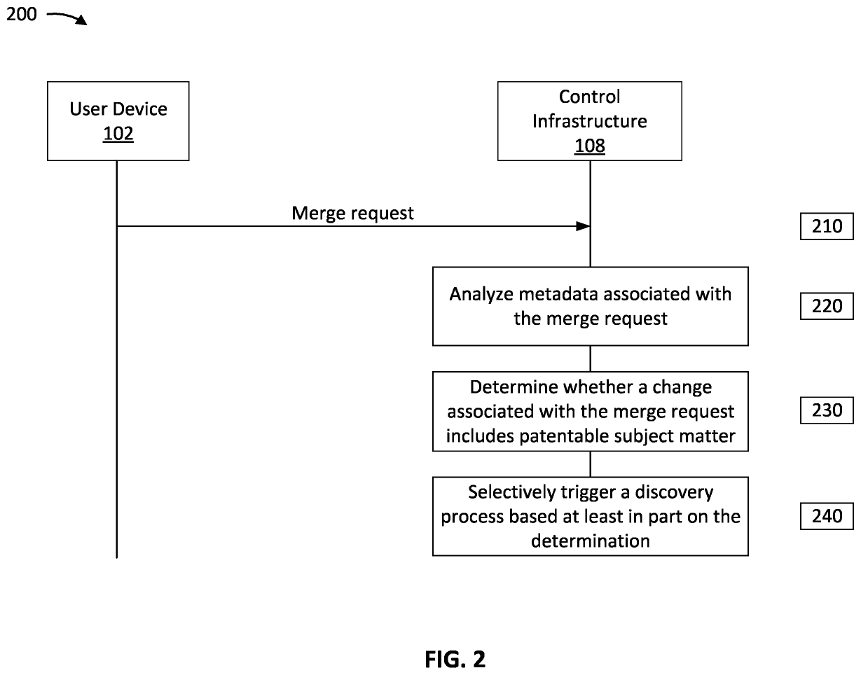

FIG. 2 is an illustration of an example flow 200 associated with automating discovery of patentable subject matter, according to various aspects of the present disclosure. The example flow 200 may include a user device 102 in communication with a control infrastructure 108, owned and operated by a business entity. In some aspects, the user device 102 and the control infrastructure 108 may be located locally (e.g., in the same room, in the same building, etc.) with respect to each other. In some aspects, the user device 102 and the control infrastructure 108 may be located remotely (e.g., in different buildings, in different cities, in different states, in different countries, etc.) with respect to each other. In some aspects, the user device 102 and the control infrastructure 108 may communicate with each other over a network (e.g., network 106) to enable provision of products and services by the business entity. As discussed in further detail, the control infrastructure 108 may enable automating discovery of patentable subject matter. Although only one user device 102 is shown in FIG. 2, the present disclosure contemplates inclusion of any number of user devices that operate in a similar and/or analogous manner as discussed herein.

In some aspects, the control infrastructure 108 may be associated with an SC database (e.g., SC database 112) that may store a source code, the execution of which may enable the business entity to provide the products and services. In some aspects a processing unit (e.g., processing unit 110) may be configured to execute the source code and/or to enable a change to the source code via, for example, receiving and processing a merge request as discussed below.

As shown by reference numeral 210, the user device 102 may transmit, and the control infrastructure 108 (e.g., processing unit 110) may receive, a merge request. In some aspects, the merge request may include a request to change at least a portion of the source code stored in the SC database 112. Such a requested change may include, for example, an addition to the source code, an update to the source code, a revision to the source code, or the like. The requested change may be directed to creating a new solution and/or improve an existing solution associated with the business entity providing products and services.

As shown by reference numeral 220, the control infrastructure 108 may determine that the received request is a merge request that includes a requested change. Based at least in part on determining that the received request is a merge request, the control infrastructure 108 may automatically analyze metadata associated with the merge request. In some aspects, the merge request may include metadata indicating information associated with the requested change. In some aspects, a user associated with the user device 102 may include the metadata in the merge request. Based at least in part on analyzing the metadata, as shown by reference numeral 230, the control infrastructure 108 may automatically conduct a preliminary determination as to whether the requested change associated with the merge request includes patentable subject matter. Further, based at least in part on a result of the determination, as shown by reference numeral 240, the control infrastructure 108 may selectively trigger a discovery process.

In an example, the metadata may indicate whether the requested change includes utilization of public components. For instance, the requested change may include adding, updating, and/or revising source code lines by proposing new lines of code. In an aspect, the metadata may indicate whether the new lines of code are developed based at least in part on utilizing public content (e.g., concepts, ideas, lines of code, etc.) that is publicly available. Such public content may include, for example, open source software, publicly licensed software, or the like. In another aspect, the metadata may indicate whether the new lines of code are developed based at least in part on utilizing private content that is not publicly available. Such private content may include, for example, newly developed software that may be internal to the business entity and may be directed to creating a new solution and/or improving an existing solution. In yet another aspect, the metadata may indicate whether the new lines of code are developed based at least in part on utilizing a combination of public content and private content.

When the metadata indicates that the new lines of code are developed based at least in part on utilizing public content, the control infrastructure 108 may determine that the new lines of code are unlikely to include patentable subject matter because of public availability of the utilized components. In this case, the control infrastructure 108 may select to refrain from triggering a discovery process. Alternatively, when the metadata indicates that the new lines of code are developed based at least in part on utilizing private content, the control infrastructure 108 may determine that the new lines of code are likely to include patentable subject matter because of the lack of public availability of the newly developed software and/or private components. In this case, the control infrastructure may select to trigger the discovery process. When the metadata indicates that the new lines of code are developed based at least in part on utilizing the combination of public content and private content, the control infrastructure 108 may determine that the new lines of code are likely to include patentable subject matter because of the lack of public availability of the newly developed software and/or private components. In this case, the control infrastructure may select to trigger the discovery process.

In another example, the metadata may indicate a type associated with the requested change. In an aspect, the metadata may indicate whether the requested change is directed to fixing an existing bug (e.g., error) in the source code. In another aspect, the metadata may indicate whether the requested change is directed to a particular solution identified as being significant and/or substantial to the products and services provided by the business entity. In yet another aspect, the metadata may indicate whether the requested change is directed to introducing a new feature in the source code.

When the metadata indicates that the new lines of code are directed to fixing an existing bug in the source code, the control infrastructure 108 may determine that the new lines of code are unlikely to include patentable subject matter because, for example, a scope associated with fixing the existing bug may be limited. In this case, the control infrastructure 108 may select to refrain from triggering a discovery process. Alternatively, when the metadata indicates that the new lines of code are directed to a particular solution identified as being significant and/or substantial to the products and services, the control infrastructure 108 may determine that the new lines of code are likely to include patentable subject matter because, for example, the business entity may want to protect solutions that are identified as being significant and/or substantial to the products and services. In this case, the control infrastructure may select to trigger the discovery process. When the metadata indicates that the new lines of code introduce a new feature, the control infrastructure 108 may determine that the new lines of code are likely to include patentable subject matter because, for example, development of the new feature may involve utilization of a novel and nonobvious process, product, machine, and/or composition. In this case, the control infrastructure may select to trigger the discovery process.

In yet another example, the metadata may indicate a size associated with the requested change. In an aspect, the metadata may indicate a number of the new lines of code included in the requested change. When the metadata indicates that the number of the new lines of code is equal to or greater than a predetermined threshold number, the control infrastructure 108 may determine that the new lines of code are likely to include patentable subject matter because, given the size associated with the requested change, the control infrastructure 108 may determine that the new lines of code include a threshold amount of content, thereby increasing a likelihood of the new lines of code involving utilization of a novel and nonobvious process, product, machine, and/or composition. In this case, the control infrastructure 108 may select to trigger the discovery process.

In some aspects, to determine whether the requested change includes patentable subject matter, the control infrastructure 108 may determine a numerical value associated with a likelihood that the requested change includes patentable subject matter. In this case, the control infrastructure 108 may selectively trigger the discovery process based at least in part on determining that the value of the likelihood that the requested change (e.g., the new lines of code) includes patentable subject matter is equal to and/or greater than a predetermined likelihood threshold value (e.g., 50%, 65%, 75%, 80%, 85%, 90%, 95%, etc.).

In some aspects, selectively triggering the discovery process may include determining discovery information that includes information regarding the merge request and/or the metadata associated with the merge request and/or a result of conducting the preliminary determination. Further, selectively triggering the discovery process may include transmitting the discovery information to a predetermined device associated with the business entity. In some aspects, appropriate personnel associated with determining whether to pursue and protect the patentable subject matter included in the requested change may have access to the predetermined device.

In this way, by relying on the control infrastructure to automatically discover and identify potentially patentable subject matter, as discussed herein, the business entity may avoid failure to identify patentable subject matter. As a result, the business entity may enhance a likelihood of increasing its intellectual property. Additionally, the business entity may avoid inefficiently expending a threshold amount of business resources (e.g., management resources, computing resources, employee resources, etc.) to discover and pursue patentable subject matter, and utilize the business resources more efficiently to provide products and services

As indicated above, FIG. 2 is provided as an example. Other examples may differ from what is described with regard to FIG. 2.

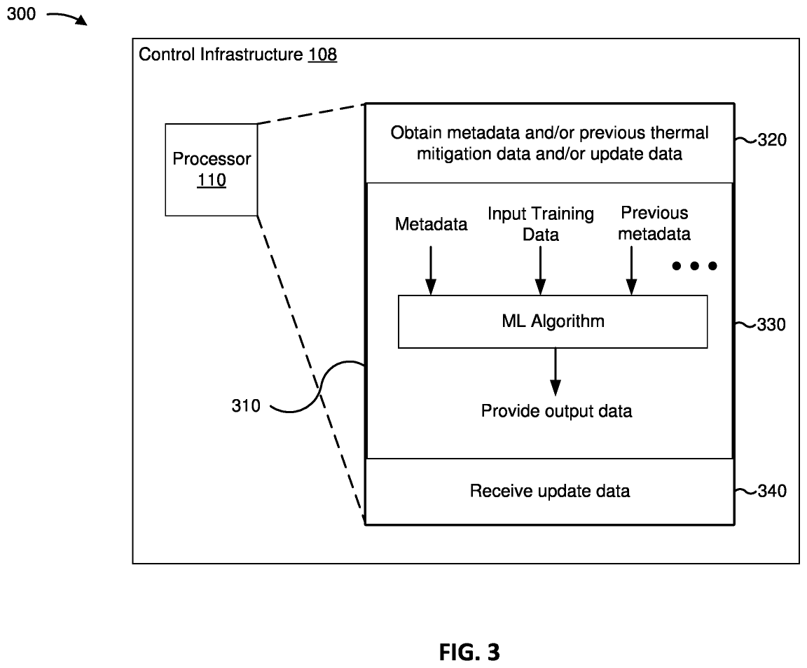

FIG. 3 is an illustration of an example 300 associated with automating discovery of patentable subject matter, according to various aspects of the present disclosure. As shown in FIG. 3, the control infrastructure 108 may include the processor 110, which may be associated with and/or include, for example, one or more processors described elsewhere herein (e.g., processor 520).

In some aspects, the processor 110 may include and/or utilize a self-learning machine learning model (ML model) 310 in connection with automating discovery of patentable subject matter. In some aspects, the ML model 310 may include a supervised learning model. In some aspects, the ML model 310 may include an unsupervised learning model. The processor 110 may utilize the ML model 310 to determine a need to perform an action related to automating discovery of patentable subject matter.

As shown by reference numeral 320, the ML model 310 may obtain training data including metadata and/or previous metadata associated with information received during at least one previous instance of automating discovery of patentable subject matter and/or update data associated with an output provided by the ML model 310 during at least one previous instance of automating discovery of patentable subject matter. In some aspects, the processor 110 may store the above training data in, and the ML model 310 may obtain the above training data from, for example, one or more memories described elsewhere herein (e.g., MR database 114, memory 530). In some aspects, the previous metadata may include historical metadata associated with the at least one previous instance of automating discovery of patentable subject matter. In some aspects, the update data may include historical output data associated with at least one previous instance of automating discovery of patentable subject matter. In some aspects, the ML model 310 may obtain input training data that is input via an interface associated with the control infrastructure 108.

As shown by reference number 330, the ML model 310 may process the training data using a machine learning algorithm (ML algorithm). In some aspects, the ML model 310 may utilize the ML algorithm to evaluate the training data to learn trends and patterns associated with discovering and identifying potentially patentable subject matter. In some aspects, the ML algorithm may evaluate and take into account feedback information (e.g., success rate) associated with previously discovered and identified potentially patentable subject matter. The ML algorithm may provide output data to the processor 110 based at least in part on the evaluated training data and the learned trends and patterns. In some aspects, the output data may indicate a value associated with the likelihood that the requested change includes patentable subject matter, thereby assisting the processor 110 in more accurately automating discovery of patentable subject matter and/or in selectively triggering the discovery process.

As shown by reference number 340, at an end of an instance of automating discovery of patentable subject matter, the ML model 310 may receive update data including at least the training data and/or the output data. In some aspects, the update data may be included in the previous metadata stored in the one or more memories (e.g., MR database 114, memory 530) to be used as training data for future iterations of automating discovery of patentable subject matter. In some aspects, the ML model 310 may evaluate the update data to learn various aspects such as accuracy, consistency, reliability, efficiency, and/or the like of the output data in enabling the processor 110 to more accurately (i) automatically analyze the metadata and/or (ii) automatically determine whether the requested change associated with the merge request includes patentable subject matter and/or (iii) automatically trigger the discovery process. In this way, the processor 110 may utilize the ML model 310 to apply a rigorous and automated process to discover and identify patentable subject matter. In some aspects, the processor 110 may more accurately (i) analyze the metadata and/or (ii) automatically determine whether the requested change associated with the merge request includes patentable subject matter and/or (iii) selectively trigger the discovery process to assist the business entity in increasing its intellectual property.

As indicated above, FIG. 3 is provided as an example. Other examples may differ from what is described in connection with FIG. 3.

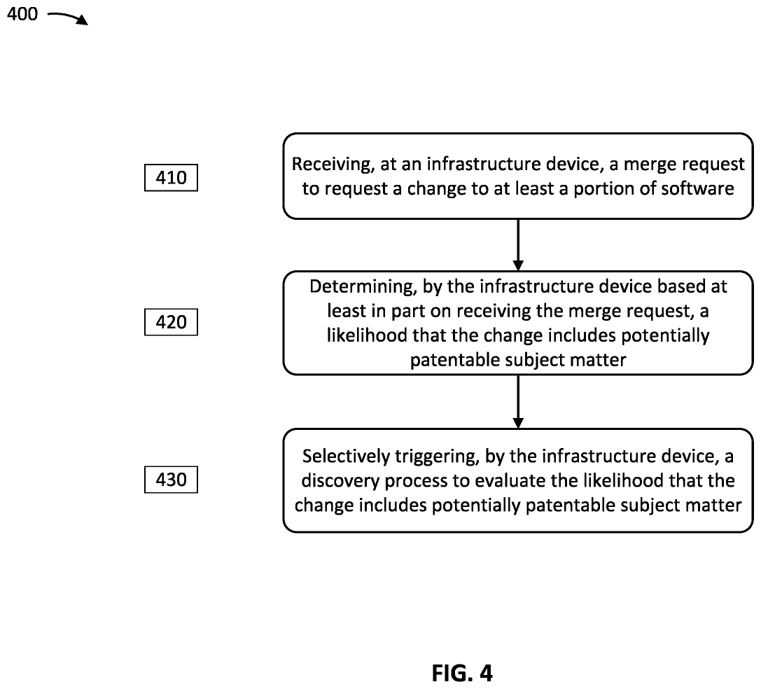

FIG. 4 is an illustration of an example process 400 associated with automating discovery of patentable subject matter, according to various aspects of the present disclosure. In some aspects, the process 400 may be performed by a memory and/or a processor/controller (e.g., processing unit 110, processor 520) associated with an infrastructure device (e.g., control infrastructure 108). As shown by reference numeral 410, process 400 may include receiving, at an infrastructure device, a merge request to request a change to at least a portion of software. For instance, the infrastructure device may utilize an associated communication interface (e.g., communication interface 570) with the associated memory and/or processor to receive a merge request to request a change to at least a portion of software, as discussed elsewhere herein.

As shown by reference numeral 420, process 400 may include determining, by the infrastructure device based at least in part on receiving the merge request, a likelihood that the change includes potentially patentable subject matter. For instance, the infrastructure device may utilize the associated memory and/or processor to determine, based at least in part on receiving the merge request, a likelihood that the change includes potentially patentable subject matter, as discussed elsewhere herein.

As shown by reference numeral 430, process 400 may include selectively triggering, by the infrastructure device, a discovery process to evaluate the likelihood that the change includes potentially patentable subject matter. For instance, the infrastructure device may utilize the associated communication interface, memory, and/or processor to selectively trigger a discovery process to evaluate the likelihood that the change includes potentially patentable subject matter, as discussed elsewhere herein.

Process 400 may include additional aspects, such as any single aspect or any combination of aspects described below and/or in connection with one or more other processes described elsewhere herein.

In a first aspect, in process 400, determining the likelihood that the change includes potentially patentable subject matter includes determining the likelihood based at least in part on whether a component associated with the change involves utilization of public content or private content.

In a second aspect, alone or in combination with the first aspect, in process 400, determining the likelihood that the change includes potentially patentable subject matter includes determining the likelihood based at least in part on whether the change is directed to introduction of a new feature in the software.

In a third aspect, alone or in combination with the first through second aspects, in process 400, determining the likelihood that the change includes potentially patentable subject matter includes determining the likelihood based at least in part on whether the change is directed to a solution identified as being significant.

In a fourth aspect, alone or in combination with the first through third aspects, in process 400, determining the likelihood that the change includes potentially patentable subject matter includes automatically analyzing metadata included in the merge request, the metadata indicating information regarding the change.

In a fifth aspect, alone or in combination with the first through fourth aspects, in process 400, determining the likelihood that the change includes potentially patentable subject matter includes utilizing a machine-learning model trained and updated by the infrastructure device.

In a sixth aspect, alone or in combination with the first through fifth aspects, in process 400, selectively triggering the discovery process includes selecting to trigger the discovery process based at least in part on determining that a value associated with a likelihood that the change includes potentially patentable subject matter is greater than or equal to a predetermined threshold value.

Although FIG. 4 shows example blocks of the process, in some aspects, the process may include additional blocks, fewer blocks, different blocks, or differently arranged blocks than those depicted in FIG. 4. Additionally, or alternatively, two or more of the blocks of the process may be performed in parallel.

As indicated above, FIG. 4 is provided as an example. Other examples may differ from what is described with regard to FIG. 4.

FIG. 5 is an illustration of example devices 500 associated with automating discovery of patentable subject matter, according to various aspects of the present disclosure. In some aspects, the example devices 500 may form part of or implement the systems, servers, environments, infrastructures, components, devices, or the like described elsewhere herein (e.g., control infrastructure, VPN server, etc.) and may be used to perform example processes described elsewhere herein. The example devices 500 may include a universal bus 510 communicatively coupling a processor 520, a memory 530, a storage component 540, an input component 550, an output component 560, and a communication interface 570.

Bus 510 may include a component that permits communication among multiple components of a device 500. Processor 520 may be implemented in hardware, firmware, and/or a combination of hardware and software. Processor 520 may take the form of a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some aspects, processor 520 may include one or more processors capable of being programmed to perform a function. Memory 530 may include a random access memory (RAM), a read only memory (ROM), and/or another type of dynamic or static storage device (e.g., a flash memory, a magnetic memory, and/or an optical memory) that stores information and/or instructions for use by processor 520.

Storage component 540 may store information and/or software related to the operation and use of a device 500. For example, storage component 540 may include a hard disk (e.g., a magnetic disk, an optical disk, and/or a magneto-optic disk), a solid state drive (SSD), a compact disc (CD), a digital versatile disc (DVD), a floppy disk, a cartridge, a magnetic tape, and/or another type of non-transitory computer-readable medium, along with a corresponding drive.

Input component 550 may include a component that permits a device 500 to receive information, such as via user input (e.g., a touch screen display, a keyboard, a keypad, a mouse, a button, a switch, and/or a microphone). Additionally, or alternatively, input component 550 may include a component for determining location (e.g., a global positioning system (GPS) component) and/or a sensor (e.g., an accelerometer, a gyroscope, an actuator, another type of positional or environmental sensor, and/or the like). Output component 560 may include a component that provides output information from device 500 (via, for example, a display, a speaker, a haptic feedback component, an audio or visual indicator, and/or the like).

Communication interface 570 may include a transceiver-like component (e.g., a transceiver, a separate receiver, a separate transmitter, and/or the like) that enables a device 500 to communicate with other devices, such as via a wired connection, a wireless connection, or a combination of wired and wireless connections. Communication interface 570 may permit device 500 to receive information from another device and/or provide information to another device. For example, communication interface 570 may include an Ethernet interface, an optical interface, a coaxial interface, an infrared interface, a radio frequency (RF) interface, a universal serial bus (USB) interface, a Wi-Fi interface, a cellular network interface, and/or the like.

A device 500 may perform one or more processes described elsewhere herein. A device 500 may perform these processes based on processor 520 executing software instructions stored by a non-transitory computer-readable medium, such as memory 530 and/or storage component 540. As used herein, the term “computer-readable medium” may refer to a non-transitory memory device. A memory device may include memory space within a single physical storage device or memory space spread across multiple physical storage devices.

Software instructions may be read into memory 530 and/or storage component 540 from another computer-readable medium or from another device via communication interface 570. When executed, software instructions stored in memory 530 and/or storage component 540 may cause processor 520 to perform one or more processes described elsewhere herein. Additionally, or alternatively, hardware circuitry may be used in place of or in combination with software instructions to perform one or more processes described elsewhere herein. Thus, implementations described herein are not limited to any specific combination of hardware circuitry and software.

The quantity and arrangement of components shown in FIG. 5 are provided as an example. In practice, a device 500 may include additional components, fewer components, different components, or differently arranged components than those shown in FIG. 5. Additionally, or alternatively, a set of components (e.g., one or more components) of a device 500 may perform one or more functions described as being performed by another set of components of a device 500.

As indicated above, FIG. 5 is provided as an example. Other examples may differ from what is described with regard to FIG. 5.

Persons of ordinary skill in the art will appreciate that the aspects encompassed by the present disclosure are not limited to the particular exemplary aspects described herein. In that regard, although illustrative aspects have been shown and described, a wide range of modification, change, and substitution is contemplated in the foregoing disclosure. It is understood that such variations may be made to the aspects without departing from the scope of the present disclosure. Accordingly, it is appropriate that the appended claims be construed broadly and in a manner consistent with the present disclosure.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” or “device” is intended to be broadly construed as hardware, firmware, or a combination of hardware and software. As used herein, a processor is implemented in hardware, firmware, or a combination of hardware and software.

As used herein, satisfying a threshold may, depending on the context, refer to a value being greater than the threshold, greater than or equal to the threshold, less than the threshold, less than or equal to the threshold, equal to the threshold, or not equal to the threshold, among other examples, or combinations thereof.

It will be apparent that systems or methods described herein may be implemented in different forms of hardware, firmware, or a combination of hardware and software. The actual specialized control hardware or software code used to implement these systems or methods is not limiting of the aspects. Thus, the operation and behavior of the systems or methods were described herein without reference to specific software code—it being understood that software and hardware can be designed to implement the systems or methods based, at least in part, on the description herein.

Even though particular combinations of features are recited in the claims or disclosed in the specification, these combinations are not intended to limit the disclosure of various aspects. In fact, many of these features may be combined in ways not specifically recited in the claims or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (for example, a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
receiving, at an infrastructure device, a merge request to request a change to at least a portion of software;
determining, by the infrastructure device based at least in part on receiving the merge request, a likelihood that the change includes potentially patentable subject matter; and
selectively triggering, by the infrastructure device, a discovery process to evaluate the likelihood that the change includes potentially patentable subject matter.

2. The method of claim 1, wherein determining the likelihood that the change includes potentially patentable subject matter includes determining the likelihood based at least in part on whether a component associated with the change involves utilization of public content or private content.

3. The method of claim 1, wherein determining the likelihood that the change includes potentially patentable subject matter includes determining the likelihood based at least in part on whether the change is directed to introduction of a new feature in the software.

4. The method of claim 1, wherein determining the likelihood that the change includes potentially patentable subject matter includes determining the likelihood based at least in part on whether the change is directed to a solution identified as being significant.

5. The method of claim 1, wherein determining the likelihood that the change includes potentially patentable subject matter includes automatically analyzing metadata included in the merge request, the metadata indicating information regarding the change.

6. The method of claim 1, wherein determining the likelihood that the change includes potentially patentable subject matter includes utilizing a machine-learning model trained and updated by the infrastructure device.

7. The method of claim 1, wherein selectively triggering the discovery process includes selecting to trigger the discovery process based at least in part on determining that a value associated with a likelihood that the change includes potentially patentable subject matter is greater than or equal to a predetermined threshold value.

8. An infrastructure device, comprising:
a memory; and
a processor communicatively coupled to the memory, the memory and the processor being configured to:
receive a merge request to request a change to at least a portion of software;
determine, based at least in part on receiving the merge request, a likelihood that the change includes potentially patentable subject matter; and
selectively trigger a discovery process to evaluate the likelihood that the change includes potentially patentable subject matter.

9. The infrastructure device of claim 8, wherein, to determine the likelihood that the change includes potentially patentable subject matter, the memory and the processor are configured to determine the likelihood based at least in part on whether a component associated with the change involves utilization of public content or private content.

10. The infrastructure device of claim 8, wherein, to determine the likelihood that the change includes potentially patentable subject matter, the memory and the processor are configured to determine the likelihood based at least in part on whether the change is directed to introduction of a new feature in the software.

11. The infrastructure device of claim 8, wherein, to determine the likelihood that the change includes potentially patentable subject matter, the memory and the processor are configured to determine the likelihood based at least in part on whether the change is directed to a solution identified as being significant.

12. The infrastructure device of claim 8, wherein, to determine the likelihood that the change includes potentially patentable subject matter, the memory and the processor are configured to automatically analyze metadata included in the merge request, the metadata indicating information regarding the change.

13. The infrastructure device of claim 8, wherein, to determine the likelihood that the change includes potentially patentable subject matter, the memory and the processor are configured to utilize a machine-learning model trained and updated by the infrastructure device.

14. The infrastructure device of claim 8, wherein, to selectively trigger the discovery process, the memory and the processor are configured to select to trigger the discovery process based at least in part on determining that a value associated with a likelihood that the change includes potentially patentable subject matter is greater than or equal to a predetermined threshold value.

15. A non-transitory computer-readable medium configured to store instructions, which when executed by a processor associated with an infrastructure device, cause the processor to:
receive a merge request to request a change to at least a portion of software;
determine, based at least in part on receiving the merge request, a likelihood that the change includes potentially patentable subject matter; and
selectively trigger a discovery process to evaluate the likelihood that the change includes potentially patentable subject matter.

16. The non-transitory computer-readable medium of claim 15, wherein, to determine the likelihood that the change includes potentially patentable subject matter, the processor is configured to determine the likelihood based at least in part on whether a component associated with the change involves utilization of public content or private content.

17. The non-transitory computer-readable medium of claim 15, wherein, to determine the likelihood that the change includes potentially patentable subject matter, the processor is configured to determine the likelihood based at least in part on whether the change is directed to introduction of a new feature in the software.

18. The non-transitory computer-readable medium of claim 15, wherein, to determine the likelihood that the change includes potentially patentable subject matter, the processor is configured to determine the likelihood based at least in part on whether the change is directed to a solution identified as being significant.

19. The non-transitory computer-readable medium of claim 15, wherein, to determine the likelihood that the change includes potentially patentable subject matter, the processor is configured to automatically analyze metadata included in the merge request, the metadata indicating information regarding the change.

20. The non-transitory computer-readable medium of claim 15, wherein, to determine the likelihood that the change includes potentially patentable subject matter, the processor is configured to utilize a machine-learning model trained and updated by the infrastructure device.
